(19) United States
(12) Patent Application Publication
(10) Pub. No.: US 2003/0066867 A1
(43) Pub. Date: Apr. 10, 2003

(54) Welding support system and method

(76) Inventors: Justin Lindahl, New London, MN (US); James H. Sladek, Battle Lake, MN (US)

Correspondence Address: Merchant & Gould P.C., P.O. Box 2903, Minneapolis, MN, 55402-0903, US

(21) Appl. No.: 09/972,696

(22) Filed: Oct. 5, 2001

(51) Int. Cl. B23K 5/22; B23K 31/02; B23K 35/12

(52) U.S. Cl. 228/213; 228/256; 228/44.3

(57) ABSTRACT

A metalworking support system has an elongate c-channel support member and a magnet in the channel acting as anchoring device for attaching the support member to a weldable element, such as an automobile body. A pry tool inserts into an orifice in the support member and is used as a lever for removing the support member from the weldable element. The support system provides support to the weldable element and acts as a heat sink to reduce warping from the welding or other operations.

### BACKGROUND OF THE INVENTION

1. Field of the Invention

The present invention is directed to a method and apparatus for providing support during metalworking to prevent warping of the articles being worked on.

2. Description of the Prior Art

Welding is a common process used in repairing automobile body damage wherein portions of the automobile body are removed and a new portion is welded onto the automobile in alignment with other body elements. Although this method provides for attaching replacement panels, such techniques often result in unintended problems, increasing the cost of repair. A common side effect of the welding operation and the extreme heat is warping or buckling of one or both of the elements being welded together. Often the element above a horizontal weld is subjected to a great degree of heat and the element warps. Such warping may be difficult to repair that causes additional warping. This increases the repair time, material needed and the overall costs of such repairs. Other operations commonly employed in automobile body repair, such as grinding and sandblasting, may also generate sufficient heat to cause warping.

In addition to warping, positioning the element so that they align and trying to maintain the elements in alignment is often a problem. Typically, clamps are utilized to maintain the elements in proper alignment during the welding operation. Tack welds may be spaced along the elements to be welded together prior to the primary welding steps. Clamps to position and hold the panels in the proper position are attached to the panels. Such a job requires careful alignment and is a time consuming task, as the clamps require time to reposition. Clamps, typically C-type clamps, may limit the accessibility to the welding area and do not always provide for the desired alignment of the two pieces or easy and quick removability.

It can be appreciated that adding a bar or other element to the panels to provide support and/or to absorb a portion of the heat generated from the welding process would decrease the warping in many instances. However, the added work of clamping, reclamping and positioning of such a bar would take additional time and permanent additional support for the panels may increase the overall weight of the automobile, decreasing performance and efficiency.

It can be seen then that a new and improved method and apparatus for maintaining welded elements in proper alignment to one another and to reduce the warping of the elements is needed. Such a device should provide good heat transfer from the welded panels and easy removability. Such elements should have sufficient surface contact with the welded elements and sufficient mass to direct heat away from the welded panels as well as providing support to the panels to permit welding. Moreover, such a welding support system and method should also provide for supporting the panels during tack welding with quick and easy removability. The present invention addresses these as well as other problems associated with welding.

### SUMMARY OF THE INVENTION

The present invention is directed to a method and apparatus for minimizing warping due to heat build up from metalworking operations such as welding, grinding and sandblasting.

The present invention includes a support device including magnets or other attachment items. In a preferred embodiment, the device includes a magnet positioned in a C-shaped channel. The sides of the channel extend slightly beyond the magnet and contact the surface that is typically ferromagnetic. The center portion of the channel includes an orifice formed therein for receiving a removal tool. The removal tool is configured to be inserted into the orifice to pivot the device up away from the working surface for removal. The support device can be used alone or in various combinations with other such devices to provide the support where needed.

The device of the present invention may be used to support the articles being welded during tack welding wherein the device spans the abutting edges and aligns the two pieces being welded together across the seam. Tack welds may be placed along the seam to temporarily secure the pieces together in desired alignment. When the tack welding is complete, the support devices are pivoted upward and removed.

The support device may also be used for standard welding or other work where heat is generated. The support device is typically placed above the work area against one of the pieces. As the heat rises, it passes to the support device, which acts as a heat sink. The lesser amount of heat passed through to the panel helps to maintain a lower temperature of the element being worked on and lessens the likelihood of warping. In addition, the magnets provide support to the outer surface to maintain the smooth shape of the outer surface of the pieces. A combination of heat retention in the mass of the support and the additional device support to the work piece decreases the likelihood of warping. In addition to magnetic attachment, the support device may also be attached with other well-known techniques such as suction and may be utilized alone or with multiple support devices to provide support at the areas most likely to warp. In addition, the devices may be interchanged as they are heated and replaced with other cooler devices, having increased capacity to absorb and retain additional heat. When the work is finished, the removal tool is inserted and the devices are pivoted up using the removal tool as a lever, for easy removal from the working surface.

These features of novelty and various other advantages which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

Referring now to the drawings, wherein like reference numerals and letters indicate corresponding structure throughout the several views:

FIG. 1 is a perspective view of support device according to the principles of the present invention;

FIG. 2 is a plan view of the contact surface of the support device shown in FIG. 1;

FIG. 3 is an end elevational view of the support device shown in FIG. 1 with a removal tool engaging the apparatus and pivoting the device up from the work surface;

FIG. 4 shows a perspective view of two support devices mounted to an automobile body during tack welding; and

FIG. 5 shows a perspective view of the support device shown in FIG. 1 mounted to an automobile body to inhibit warping during welding.

### DETAILED DESCRIPTION OF THE PREFERRED EMBODIMENT

Referring to the drawings, and in particular to FIG. 1, there is shown first embodiment of a support device, generally designated 10, for use in welding, grinding, and sandblasting and other metalworking operations. It has been found that the support device 10 is particularly useful for automobile body repair work. The support device includes a body 16 having a C-channel profile with a top portion 18 and channel side portions 20. One or more magnets 14 are retained within the C-channel. In a preferred embodiment, the ends of the channel portions 20 extend slightly beyond the outer surface of the magnets 14. Although magnets 14 are shown, it is also possible that other embodiments are foreseen that utilize other attachment methods, such as tack welding to the surface being worked, clamping, suction and other well known mounting techniques.

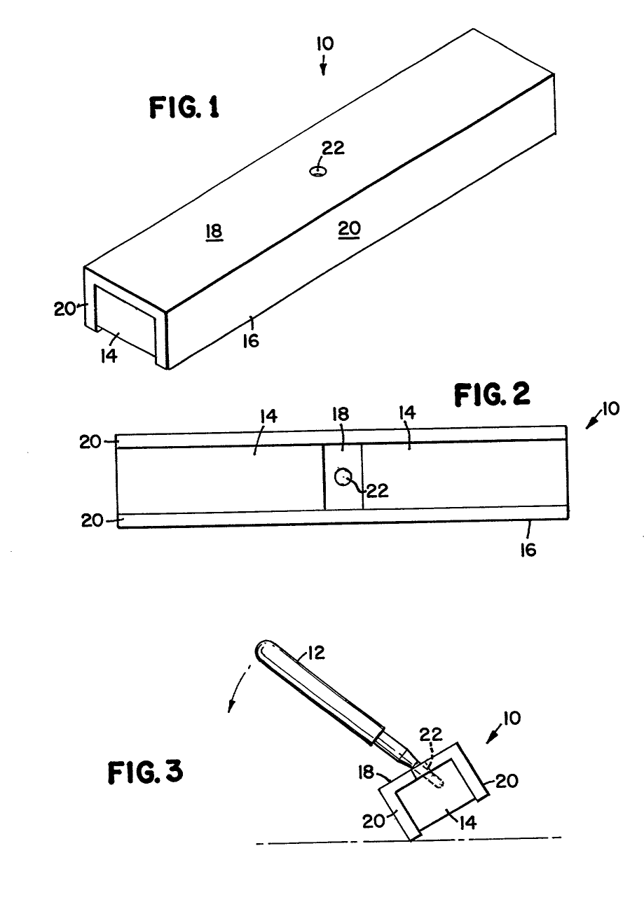

As shown in FIG. 2 the contact surface has the edges of the channel portion 20 along the sides of the device 10. The magnets 14 attract the device and retain it against the surface, as explained hereinafter so that the magnets 14 are spaced a small distance apart from the surface.

The top portion 18 of the channel includes pivot orifice 22 which is configured to receive a pivot tool 12, as shown in FIG. 3. The force of the magnet 14 against the ferromagnetic elements to which it attaches is typically too strong to allow for simple hand removal. Therefore, the pivot tool 12 is inserted in the orifice 22 and used as a lever to pivot the device 10 up along one of the edges. Once the device 10 has been pivoted upward, the magnetic field is shifted and the attraction from the magnet is lowered such that the device may be simply pulled off without further tools.

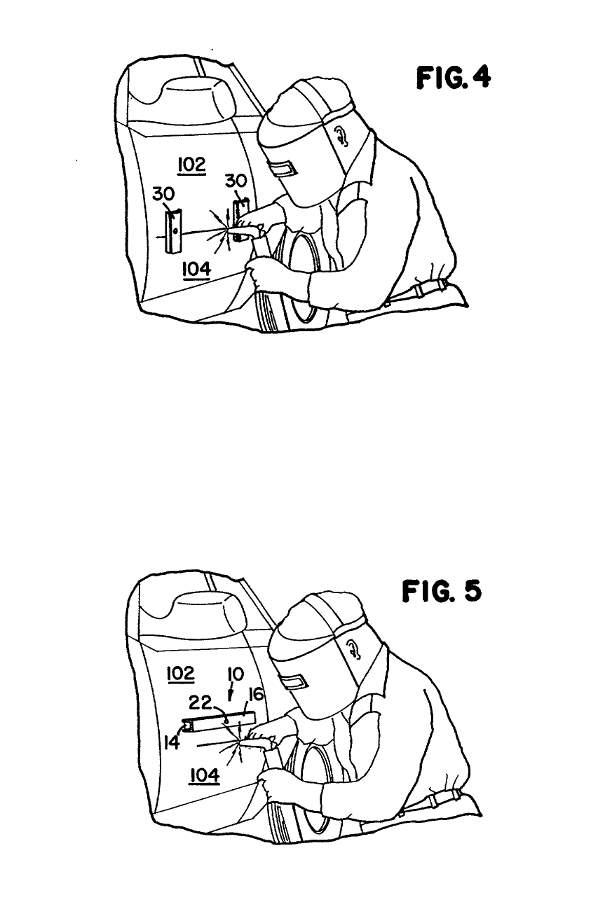

Referring now to FIGS. 4 and 5, there are shown two different uses of the present support device 10. As shown in FIG. 5, the support device 10 can be mounted to the automobile body or fender to minimize warping due to heat from welding, grinding, sandblasting or other metalworking operations. As shown in FIG. 4, the support device 10 may be utilized to hold first and second body panels or panel portions 102 and 104 in position while the panels are tack welded. As shown in FIG. 4, shorter support devices 30 may be utilized to hold the portions of the body panel 102 and 104 relative to one another for support at multiple locations. The support devices 30 are similar to the support device 10, differing only in dimensions.

It is often difficult to maintain the first portion of the panel 102 and the second portion of the panel 104 in proper alignment during the multiple welding operations. It is even more difficult if completely separated elements are being attached. Therefore, tack welds are often spaced along the abutting edges of the welded portions 102 and 104 to hold them while a full, permanent weld is made. To provide proper alignment while the tack welds are made, the support devices 30 are spaced apart, spanning the weld seam between the panel portions 102 and 104. The support devices 30 provide sufficient support during the tack weld operations so that added alignment devices, such as C-clamps, may not be required. When the tack welds are fully hardened and set, the support devices 30 are simply pivoted upward with the pivot tool 12, as shown in FIG. 3 and removed. The use of the magnet support reduces the need for unwieldy clamps and long set up that was required with prior devices.

Referring to FIG. 5, when full welding operations, grinding or other metalworking operations are performed that generate high temperatures in the body panels, the support device can be placed proximate the piece. As heat generally rises within the pieces, the support device 10 is generally placed above the area where the work is performed, as generally shown in FIG. 5. In addition, as additional support may be needed, multiple devices 10 or 30 may be placed above the area where the work is performed. Prior to beginning the weld, the support device 10 is generally placed above the weld line. As the welding is being performed, heat rises within the work piece, increasing the temperature of the piece, sometimes causing warping without support. However, the present support device 10 provides added structure and rigidity to minimizing warping. In addition, the support device 10 also acts as a heat sink to retain much of heat that would otherwise extend through the body panels 102 and 104. Using multiple devices 10 or 30 increases the mass of the heat sink, further maintaining lower temperatures.

Referring again to FIGS. 1-3, the design of the support device 10 provides for minimal contact with the work piece while providing a large mass to act as a heat sink spaced apart from the work piece with the magnets 14 positioned against the top portion 18 of the C-channel to absorb heat in a location spaced apart from the work piece. It is believed that with the added support to the panels and the lower temperatures of the pieces due to a decrease in heat retained in the work pieces, the warping is minimized or eliminated. It is also envisioned that some of the support devices 10 and 30 may be replaced with a cooler support device to provide continuous support for improved heat removal from work pieces. Multiple support devices 10 and 30 may also be utilized to provide a larger heat sink having an increased mass. Although magnets are shown for mounting and retaining the support device 10, the device could be retained with suction or tack welds that could be later ground off or other attachment methods that provide for removal of the support device.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A metalworking support system, comprising:
a support member;
an anchoring device for attaching the support member to a weldable element;
a pry tool for removing the support member from the weldable element.

2. A metalworking support system according to claim 1, wherein the support member comprises an elongate element.

3. A metalworking support system according to claim 1, wherein the anchoring device comprises a magnet.

4. A metalworking support system according to claim 3, wherein the magnet is spaced apart from an edge of the support member.

5. A metalworking support system according to claim 1, wherein the support member includes an orifice configured for receiving the pry tool.

6. A metalworking support system according to claim 1, wherein the system comprises a plurality of support members.

7. A metalworking support system according to claim 6, wherein the plurality of support members comprise a plurality of different lengths.

8. A metalworking support system according to claim 3, wherein the support member comprises a body having a C-channel profile with a top portion and channel side portions.

9. A metalworking support system according to claim 8, wherein the magnet is spaced apart from an edge of the channel side portions.

10. A metalworking support system according to claim 8, wherein the top portion includes an orifice formed therein for receiving the pry tool.

11. A method of reducing warping from welding, comprising the steps of:
providing a support member having an anchoring device;
removably mounting the support member directly to a first element to be welded above a weld area;
welding a second element to the first element;
removing the support member from the first element.

12. A method according to claim 11, wherein the anchoring device comprises a magnet.

13. A method according to claim 11, wherein the support member comprises a C channel.

14. A method according to claim 11, wherein the support member has an orifice formed therein and wherein the method comprises the further steps of:
supplying a pry tool,
inserting the pry tool into the orifice;
pivoting the support member away from the first element with the pry tool.

15. A method according to claim 11, wherein prior to mounting the support member to the first element, the method comprises the further steps of:
removably mounting the support member to the first and second elements to maintain the first and second elements relative to one another;
tacking the first and second elements together;
removing the support member from the first and second elements.

16. A method according to claim 11, wherein the support element comprises a heat sink having a mass spaced apart from the first element.

17. A method of reducing warping from automobile body repair, comprising the steps of:
providing a support member having an anchoring device adapted for mounting to an automobile body;
removably mounting the support member directly to a first portion of the automobile body to be welded above a weld area;
welding a second portion of the automobile body to the first portion of the automobile body;
removing the support member from the automobile body.

18. A method according to claim 17, wherein the anchoring device comprises a magnet mounted to the support member.

19. A method according to claim 17, wherein the support member comprises a C channel shaped element.

20. A method according to claim 17, wherein the support member has an orifice formed therein and wherein the method comprises the further steps of:
supplying a pry tool,
inserting the pry tool into the orifice;
pivoting the support member away from the automobile body.

21. A method according to claim 17, wherein prior to mounting the support member to the automobile body, the method comprises the further steps of:
removably mounting the support member to the first and second portions of the automobile body to maintain the first and second portions relative to one another;
tacking the first and second portions of the automobile body together;
removing the support member from the automobile body.

22. A method according to claim 19, wherein the support element defines a C-channel profile with a top portion and channel side portions, and wherein the magnet is spaced apart from an edge of the channel side portions.
